(19) United States
(12) Patent Application Publication
(10) Pub. No.: US 2023/0088529 A1
(43) Pub. Date: Mar. 23, 2023

(54) SITE RESILIENCY ON STRETCHED CLUSTERS

(71) Applicant: VMware, Inc., Palo Alto, CA (US)

(72) Inventors: Richard BHULESKAR, Milpitas, CA (US); Varun SHAH, Fremont, CA (US); Asit DESAI, Cupertino, CA (US)

(21) Appl. No.: 17/479,348

(22) Filed: Sep. 20, 2021

(51) Int. Cl. G06F 3/06

(52) U.S. Cl. CPC G06F 3/0619; G06F 3/067; G06F 3/0664

(57) ABSTRACT

A method for dynamic fault tolerance in a stretched storage cluster is provided. Embodiments include determining that data of a storage object is unavailable on a first site in a multi-site storage cluster comprising: the first site; a second site; and a witness node. Embodiments include modifying a voting arrangement for the storage object so that votes from the second site can achieve a quorum without any votes from the first site or the witness node. Embodiments include determining that the witness node is unavailable. Embodiments include, after determining that the witness node is unavailable, allowing data to be read from or written to one or more entities of the second site based on the quorum being achieved.

### BACKGROUND

Distributed systems allow multiple clients in a network to access a pool of shared resources. For example, a distributed storage system, such as a distributed virtual storage area network (vSAN) datastore, allows a cluster of host computers to aggregate local disks (e.g., SSD, PCI-based flash storage, SATA, or SAS magnetic disks) located in or attached to each host computer to create a single and shared pool of storage. This pool of storage (sometimes referred to herein as a “datastore” or “store”) is accessible by all host computers in the cluster and may be presented as a single namespace of storage entities (such as a hierarchical file system namespace in the case of files, a flat namespace of unique identifiers in the case of objects, etc.). Storage clients in turn, such as virtual machines, spawned on the host computers may use the datastore, for example, to store objects (e.g., virtual disks) that are accessed by the virtual machines (VMs) during their operations.

A hyper-converged infrastructure (HCl) is a software-defined infrastructure in which the traditional three-tier infrastructure (i.e., compute, storage, and networking) is virtualized in order to reduce complexity and, at the same time, increase scalability. For example, an HCl datacenter, in which storage, compute, and networking elements of the datacenter are virtualized, has significantly higher scalability and less complexity, compared to a conventional (or hardware-defined) datacenter. In an HCl datacenter, an application may run on several different virtual machines or other types of virtual computing instances (VCIs), such as containers, etc.

A VCI may include one or more objects (e.g., virtual disks) that are stored in an object-based datastore (e.g., vSAN) of the datacenter. Each object may include one or more components depending on the storage policy that is defined (e.g., by an administrator) for the object. For example, based on a storage policy that requires high availability for an object, the datastore may define two or more components for the object that are mirrors of each other and distributed across different hosts (e.g., servers). Conversely, if a storage policy requires higher performance, the datastore may specify two or more components for the object that are distributed across different disks. A component may be a part of, or portion of, an object. The different components of an object, also referred to as “object components,” may be stored in different storage resources (e.g., one or more physical disks of one or more host machines) of the datastore.

In some cases a cluster is configured as a “stretched cluster,” in which the host systems are spread across at least two different physical locations, known as sites. In some cases, a site may be a data center. VCIs may be stretched across these sites from a storage perspective such that the VCIs' storage objects are replicated on host system(s) at each site.

Typically, a VCI that is stretched in this manner (referred to as a “stretched VCI”) will access the replica copies of its storage objects that reside at the site where the VCI is currently running (referred to as “site-local replica copies”). If a stretched VCI loses access to these site-local replica copies due to, e.g., host or network failures, HCl platforms may redirect the VCI's I/O requests for its storage objects to the replica copies maintained at the other site of the stretched cluster (referred to as “site-remote replica copies”) and/or may migrate the VCI to the other site.

A stretched cluster generally requires more than half the nodes (e.g., host systems, physical computing devices, etc.) to be available, which is referred to as a quorum, on a given site for data to be read or written from that given site. Quorum prevents split-brain scenarios that can occur if there is a partition in the network and subsets of nodes cannot communicate with one another. In such cases, both subsets of nodes may try to handle an I/O operation, and may write to the same disk, thus leading to numerous problems. These split-brain scenarios are avoided through the concept of quorum, in which available nodes vote and only a group of nodes that achieves a quorum will proceed.

Thus, if two subsets of nodes in a cluster become unable to communicate with one another, the concept of quorum will force the cluster service to stop in one of the subsets of nodes (e.g., if that subset cannot achieve a quorum) to ensure that there is only one owner of a particular resource group. Once nodes that have been stopped can once again communicate with the other nodes in the cluster, they will rejoin the cluster and start their cluster service.

A witness node may be a member of a quorum to act as a tie-breaker for cases when the election results end in a tie, and to prevent split-brain situations for a quorum. A witness node does not necessarily participate in storing data, but may participate in coordinating state information of the quorum, such as by storing quorum state information, and will be assigned one or more votes. In a stretched cluster that spans multiple sites, there may be a witness node within each site (to prevent split-brain scenarios within a site) and/or a witness node in its own separate site (to prevent split-brain scenarios across sites). Witness nodes may be physical hosts, VCIs (e.g., VMs, virtual appliances, etc.), and/or the like.

Storage objects may be associated with fault tolerance policies indicating an extent to which objects are to be tolerant of host failures. A fault tolerance policy may, for example, indicate a number of host failures to tolerate (HFT), meaning that an object must be implemented in such a way as to guarantee data access even in the event that a certain number of hosts fail. In the case of a stretched cluster, an HFT policy may apply to each site included in the stretched cluster (e.g., the number of host failures indicated in the HFT policy may be tolerated on each site individually or the number of host failures indicated in the HFT policy may apply to all sites together). Generally, objects including sensitive data will be assigned a higher number of HFT.

In certain cases, a first site in a multi-site cluster may become unavailable (e.g., due to loss of connectivity), but data availability may still be able to be achieved at one or more other sites in the cluster. For example, if a storage object has a HFT of 1, and no more than one host has failed at a second site in the multi-site cluster, then the storage object should still be able to be read and written to on the second site. However, if a witness node becomes unavailable in addition to the first site being unavailable, the nodes of the second site may be unable to reach a number of votes sufficient for a quorum. Thus, in such cases, the storage object may be treated as unavailable even though it should be able to be read from and written to on the second site.

Accordingly, there is a need in the art for improved techniques of data accessibility in stretched clusters.

### BRIEF DESCRIPTION OF THE DRAWINGS

FIG. 1 is a diagram illustrating an example computing environment in which embodiments of the present application may be practiced.

FIG. 2 is a diagram illustrating an example hierarchical structure of objects organized within an object store that represent a virtual disk, according to an example embodiment of the present application.

FIG. 3 is an illustration of a stretched cluster, according to an example embodiment of the present application.

FIG. 4 is a diagram illustrating an example voting arrangement for a storage object associated with a stretched cluster.

FIG. 5 is a diagram illustrating another example voting arrangement for a storage object associated with a stretched cluster.

FIG. 6 illustrates example operations for dynamic fault tolerance in a stretched storage cluster.

### DETAILED DESCRIPTION

Objects (e.g., a virtual disk of a VM stored as a virtual disk file) in a distributed object-based datastore, such as vSAN, may be maintained on a cluster of nodes that encompasses a plurality of sites. In order to ensure continued data availability while avoiding split-brain scenarios, a voting procedure may be utilized wherein each node is assigned a certain number of votes. One or more witness nodes may also be assigned one or more votes to assist in breaking ties in the event that two subsets of nodes with equal vote totals become unable to communicate with one another. However, if one site in a multi-site cluster becomes unavailable and a witness node also becomes unavailable, a remaining site in the multi-site cluster may be unable to achieve a quorum, even though it may be able to provide full data availability. Accordingly, embodiments of the present disclosure involve modifying a voting arrangement in certain cases to allow a quorum to be achieved by one site without requiring any votes from another (unavailable) site or from a witness node.

In a particular example, a storage object that is stored on a cluster spanning two sites and has a number of host failures to tolerate (HFT) of 1 requires a witness node separate from the two sites to act as a tie-breaker between the two sites in the event that the two sites become partitioned or are otherwise unable to communicate with one another. If one of the sites becomes unavailable (e.g., due to a planned or unplanned outage), a storage object with an HFT of 1 would still be accessible as long as there is a replica available on the other site. However, if the witness node becomes unavailable during this time, the storage object will become inaccessible due to an inability to achieve a quorum even though one replica is still available on the other surviving site. As such, techniques described herein involve modifying a voting arrangement when one site fails by assigning a majority of votes to the surviving site. In one example, each node on the failed site is assigned 1 vote, which is a default value, the witness node is assigned 0 votes, and the nodes of the surviving site are assigned enough votes to achieve a quorum without any votes from the failed site or the witness node.

Thus, techniques described herein make a multi-site cluster more resilient, allowing a storage object that has a dual site mirroring policy to remain accessible even when a site and a witness node fail. If a previously failed site subsequently recovers and is also able to connect to the witness node, the storage object may continue to remain inaccessible on the previously failed site until the previously failed site has been synchronized with the current state of the data, thus ensuring that stale data is not utilized. Once the previously failed site has been synchronized, and therefore provides data availability once again, the voting arrangement may be restored to its prior state, with votes again being distributed among both sites and the witness node.

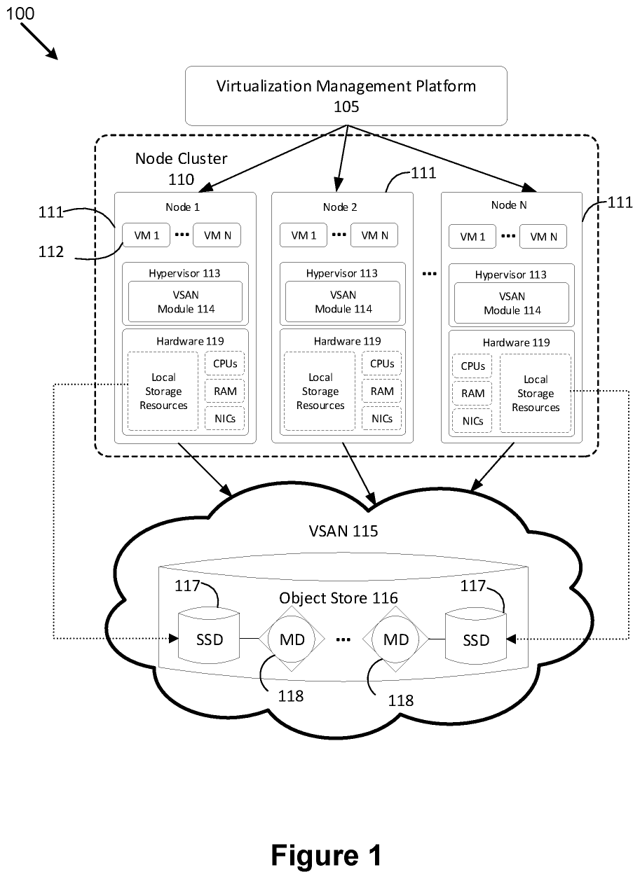

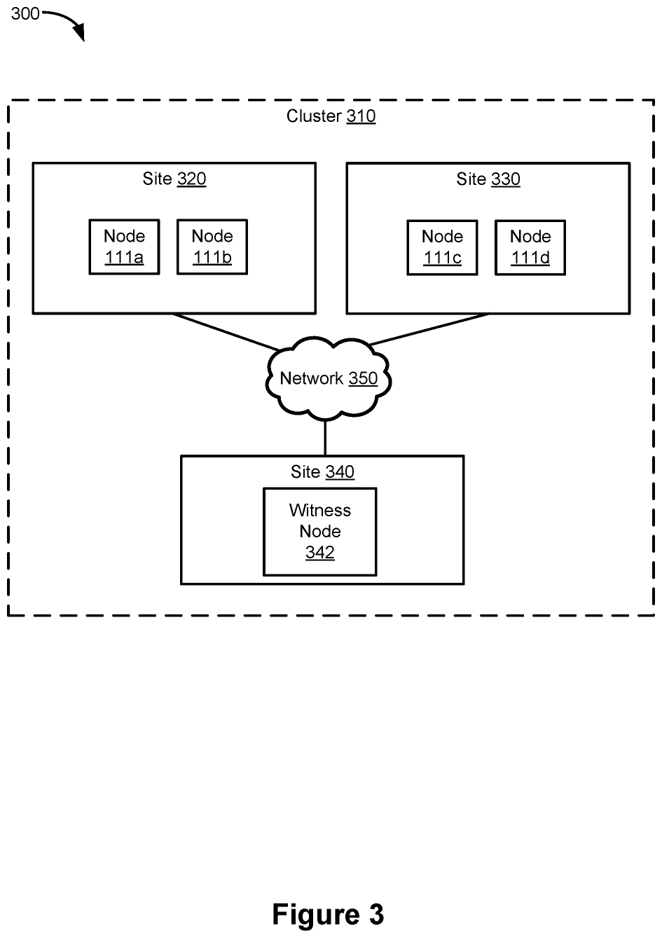

FIG. 1 is a diagram illustrating an example computing environment 100 in which embodiments of the present application may be practiced. As shown, computing environment 100 includes a distributed object-based datastore, such as a software-based “virtual storage area network” (vSAN) environment that leverages the commodity local storage housed in or directly attached (hereinafter, use of the term “housed” or “housed in” may be used to encompass both housed in, or otherwise directly attached) to host machines/servers or nodes 111 of a storage cluster 110 to provide an aggregate object store 116 to virtual machines (VMs) 112 running on the nodes. A described in more detail below with respect to FIG. 3, storage cluster 110 may encompass multiple sites. For example, some of nodes 111 may be located on a first site and other nodes 111 may be located on a second site. Storage cluster 110 may, for example, be a stretched cluster. The local commodity storage housed in the nodes 111 may include one or more of solid state drives (SSDs) or non-volatile memory express (NVMe) drives 117, magnetic or spinning disks or slower/cheaper SSDs 118, or other types of storages.

In certain embodiments, a hybrid storage architecture may include SSDs 117 that may serve as a read cache and/or write buffer (e.g., also known as a performance/cache tier of a two-tier datastore) in front of magnetic disks or slower/cheaper SSDs 118 (e.g., in a capacity tier of the two-tier datastore) to enhance the I/O performances. In certain other embodiments, an all-flash storage architecture may include, in both performance and capacity tiers, the same type of storage (e.g., SSDs 117) for storing the data and performing the read/write operations. Additionally, it should be noted that SSDs 117 may include different types of SSDs that may be used in different layers (tiers) in some embodiments. For example, in some embodiments, the data in the performance tier may be written on a single-level cell (SLC) type of SSD, while the capacity tier may use a quad-level cell (QLC) type of SSD for storing the data. In some embodiments, each node 111 may include one or more disk groups with each disk group having one cache storage (e.g., one SSD 117) and one or more capacity storages (e.g., one or more magnetic disks and/or SSDs 118).

As further discussed below, each node 111 may include a storage management module (referred to herein as a “vSAN module”) in order to automate storage management workflows (e.g., create objects in the object store, etc.) and provide access to objects in the object store (e.g., handle I/O operations on objects in the object store, etc.) based on predefined storage policies specified for objects in the object store. For example, because a VM may be initially configured by an administrator to have specific storage requirements (or policy) for its “virtual disk” depending on its intended use (e.g., capacity, availability, performance or input/output operations per second (IOPS), etc.), the administrator may define a storage profile or policy for each VM specifying such availability, capacity, performance and the like. As further described below, the vSAN module may then create an “object” for the specified virtual disk by backing it with physical storage resources of the object store based on the defined storage policy, including complying with a dynamic fault tolerance policy as described herein.

A virtualization management platform 105 is associated with cluster 110 of nodes 111. Virtualization management platform 105 enables an administrator to manage the configuration and spawning of the VMs on the various nodes 111. As depicted in the embodiment of FIG. 1, each node 111 includes a virtualization layer or hypervisor 113, a vSAN module 114, and hardware 119 (which includes the SSDs 117 and magnetic disks 118 of a node 111). Through hypervisor 113, a node 111 is able to launch and run multiple VMs 112. Hypervisor 113, in part, manages hardware 119 to properly allocate computing resources (e.g., processing power, random access memory, etc.) for each VM 112. Furthermore, as described below, each hypervisor 113, through its corresponding vSAN module 114, may provide access to storage resources located in hardware 119 (e.g., SSDs 117 and magnetic disks 118) for use as storage for storage objects, such as virtual disks (or portions thereof) and other related files that may be accessed by any VM 112 residing in any of nodes 111 in cluster 110.

In one embodiment, vSAN module 114 may be implemented as a “vSAN” device driver within hypervisor 113. In such an embodiment, vSAN module 114 may provide access to a conceptual “vSAN” 115 through which an administrator can create a number of top-level “device” or namespace objects that are backed by object store 116, including specifying dynamic fault tolerance policies as described herein. For example, during creation of a device object, the administrator may specify a particular file system for the device object (such device objects may also be referred to as “file system objects” hereinafter) such that, during a boot process, each hypervisor 113 in each node 111 may discover a/vsan/root node for a conceptual global namespace that is exposed by vSAN module 114. By accessing APIs exposed by vSAN module 114, hypervisor 113 may then determine all the top-level file system objects (or other types of top-level device objects) currently residing in vSAN 115.

When a VM (or other client) attempts to access one of the file system objects, hypervisor 113 may then dynamically “auto-mount” the file system object at that time. In certain embodiments, file system objects may further be periodically “auto-unmounted” when access to objects in the file system objects cease or are idle for a period of time. A file system object (e.g., /vsan/fs_name1, etc.) that is accessible through vSAN 115 may, for example, be implemented to emulate the semantics of a particular file system, such as a distributed (or clustered) virtual machine file system (VMFS) provided by VMware Inc. VMFS is designed to provide concurrency control among simultaneously accessing VMs. Because vSAN 115 supports multiple file system objects, it is able to provide storage resources through object store 116 without being confined by limitations of any particular clustered file system. For example, many clustered file systems may only scale to support a certain amount of nodes 111. By providing multiple top-level file system object support, vSAN 115 may overcome the scalability limitations of such clustered file systems.

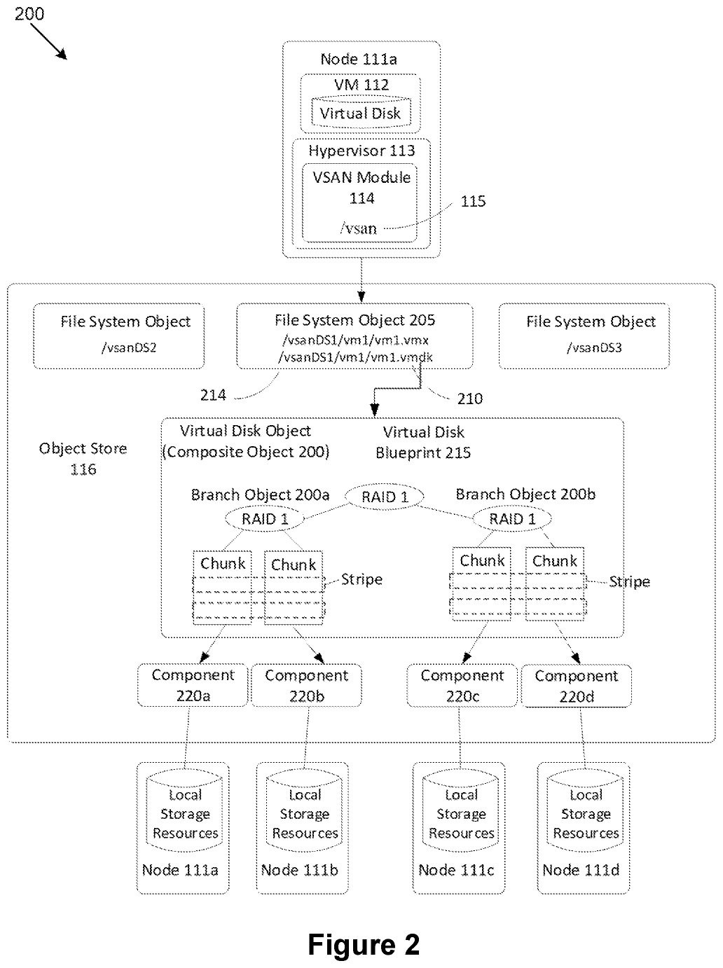

As described in further detail in the context of FIG. 2 below, a file system object may, itself, provide access to a number of virtual disk descriptor files accessible by VMs 112 running in cluster 110. These virtual disk descriptor files may contain references to virtual disk “objects” that contain the actual data for the virtual disk and are separately backed by object store 116. A virtual disk object may itself be a hierarchical, “composite” object that is further composed of “components” (again separately backed by object store 116) that reflect the storage requirements (e.g., capacity, availability, IOPs, etc.) of a corresponding storage profile or policy generated by the administrator when initially creating the virtual disk. Each vSAN module 114 (through a cluster level object management or “CLOM” sub-module, in embodiments as further described below) may communicate with other vSAN modules 114 of other nodes 111 to create and maintain an in-memory metadata database (e.g., maintained separately but in synchronized fashion in the memory of each node 111) that may contain metadata describing the locations, configurations, policies and relationships among the various objects stored in object store 116.

This in-memory metadata database is utilized by a vSAN module 114 on a node 111, for example, when a user (e.g., an administrator) first creates a virtual disk for a VM as well as when the VM is running and performing I/O operations (e.g., read or write) on the virtual disk. vSAN module 114 (through a distributed object manager or “DOM” sub-module), in some embodiments, may traverse a hierarchy of objects using the metadata in the in-memory database in order to properly route an I/O operation request to the node (or nodes) that houses (house) the actual physical local storage that backs the portion of the virtual disk that is subject to the I/O operation.

In some embodiments, one or more nodes 111 of node cluster 110 may be located at a geographical site that is distinct from the geographical site where the rest of nodes 111 are located, such as in the case of a stretched cluster. For example, some nodes 111 of node cluster 110 may be located at building A while other nodes may be located at building B. In another example, the geographical sites may be more remote such that one geographical site is located in one city or country and the other geographical site is located in another city or country. In such embodiments, any communications (e.g., I/O operations) between the DOM sub-module of a node at one geographical site and the DOM sub-module of a node at the other remote geographical site may be performed through a network, such as a wide area network (“WAN”) (e.g., network 350 of FIG. 3). Furthermore, one or more witness nodes may also be included in cluster 110.

FIG. 2 is a diagram 200 illustrating an example hierarchical structure of objects organized within an object store 116 that represent a virtual disk, according to an example embodiment of the present application. As previously discussed above, a VM 112 running on one of nodes 111 may perform I/O operations on a virtual disk that is stored as a hierarchical composite object 200 in object store 116. Hypervisor 113 may provide VM 112 access to the virtual disk by interfacing with the abstraction of vSAN 115 through vSAN module 114 (e.g., by auto-mounting the top-level file system object 214 corresponding to the virtual disk object 200). For example, vSAN module 114, by querying its local copy of the in-memory metadata database, may be able to identify a particular file system object 205 (e.g., a VMFS file system object in one embodiment, etc.) stored in vSAN 115 that may store a descriptor file 210 for the virtual disk.

Descriptor file 210 may include a reference to composite object 200 that is separately stored in object store 116 and conceptually represents the virtual disk (and thus may also be sometimes referenced herein as a virtual disk object). Composite object 200 may store metadata describing a storage organization or configuration for the virtual disk (sometimes referred to herein as a virtual disk “blueprint”) that suits the storage requirements or service level agreements (SLAs) in a corresponding storage profile or policy (e.g., capacity, availability, IOPs, etc.) generated by a user (e.g., an administrator) when creating the virtual disk. For example, composite object 200 may store a fault tolerance policy that specifies a number of HFT for composite object 200.

Depending on the desired storage policy (e.g., desired level of performance efficiency, HFT, and the like), a virtual disk blueprint 215 may direct data corresponding to composite object 200 to be stored in the datastore in a variety of ways. As described, the storage policy may be used to determine an HFT and/or stripe width (SW) associated with an object. FIG. 2 shows (composite) object 200 that includes a virtual disk blueprint 215 describing a RAID 1 configuration where two mirrored copies of the virtual disk (e.g., mirrors) are each further striped in a RAID 1 configuration. In an example, the storage policy for virtual disk file 200 specifies a stripe width of three (SW=2) and a dynamic fault tolerance policy that, when evaluated, results in an HFT of one (HFT=1). Branch objects 200a and 200b represent replicas of the same object.

Data striping, in some embodiments, may refer to segmenting logically sequential data, such as a virtual disk. Each stripe may contain a plurality of data blocks. In some cases, each stripe may also include one or more code blocks (e.g., in the case of RAID 5 or RAID 6). As shown, the stripes are split vertically into different groups of blocks, referred to as chunks, where each chunk is logically represented as a “leaf” or “component” to which composite object 200 may contain a reference.

The metadata accessible by vSAN module 114 in the in-memory metadata database for each component 220 provides a mapping to or otherwise identifies a particular node 111 in cluster 110 that houses the physical storage resources (e.g., magnetic disks or slower/cheaper SSD 118, etc.) that actually store the chunk (as well as the location of the chunk within such physical resource).

In certain embodiments, vSAN module 114 may execute as a device driver exposing an abstraction of a vSAN 115 to hypervisor 113. Various sub-modules of vSAN module 114 handle different responsibilities and may operate within either user space or kernel space depending on such responsibilities. In some embodiments, vSAN module 114 generates virtual disk blueprints during creation of a virtual disk by a user (e.g., an administrator) and ensures that objects created for such virtual disk blueprints are configured to meet storage profile or policy requirements set by the user. In addition to being accessed during object creation (e.g., for virtual disks), vSAN module 114 may also be accessed (e.g., to dynamically revise or otherwise update a virtual disk blueprint or the mappings of the virtual disk blueprint to actual physical storage in object store 116) based on a change made by a user to the storage profile or policy relating to an object, when changes to the cluster or workload result in an object being out of compliance with a current storage profile or policy, or when changes to the cluster or workload cause re-evaluation of a dynamic fault tolerance policy.

In one embodiment, if a user creates a storage profile or policy for a composite object such as virtual disk object 200, vSAN module 114 applies a variety of heuristics and/or distributed algorithms to generate virtual disk blueprint 215 that describes a configuration in cluster 110 that meets or otherwise suits the storage policy (e.g., RAID configuration to achieve desired redundancy through mirroring and access performance through striping, which nodes' local storage should store certain portions/partitions/chunks of the virtual disk to achieve load balancing, etc.). For example, vSAN module 114, in one embodiment, may be responsible for generating blueprint 215 describing the RAID 1/RAID 1 configuration for virtual disk object 200 in FIG. 2 when the virtual disk was first created by the user. As previously discussed, a storage policy may specify requirements for capacity, IOPS, availability, and reliability. Storage policies may also specify a workload characterization (e.g., random or sequential access, I/O request size, cache size, expected cache hit ration, etc.).

Additionally, the user may also specify an affinity to vSAN module 114 to preferentially use certain nodes 111 (or the local disks housed therein). For example, when provisioning a new virtual disk for a VM, a user may generate a storage policy or profile for the virtual disk specifying that the virtual disk have a reserve capacity of 400 GB, a reservation of 150 read IOPS, a reservation of 300 write IOPS, and a desired availability of 99.99%. Upon receipt of the generated storage policy, vSAN module 114 may consult the in-memory metadata database to determine the current state of cluster 110 in order to generate a virtual disk blueprint for a composite object (e.g., the virtual disk object) that suits the generated storage policy. As further discussed below, vSAN module 114 may interact with object store 116 to implement the blueprint by, for example, allocating or otherwise mapping components (e.g., chunks) of the composite object to physical storage locations within various nodes 111 of cluster 110.

In some embodiments, vSAN module 114 may also include a cluster monitoring, membership, and directory services (CMMDS) sub-module that maintains the previously discussed in-memory metadata database to provide information on the state of cluster 110 to other sub-modules of vSAN module 114 and also tracks the general “health” of cluster 110 by monitoring the status, accessibility, and visibility of each node 111 in cluster 110. The in-memory metadata database may serve as a directory service that maintains a physical inventory of the vSAN environment, such as the various nodes 111, the storage resources in the nodes 111 (SSD, NVMe drives, magnetic disks, etc.) housed therein and the characteristics/capabilities thereof, the current state of the nodes 111 and their corresponding storage resources, network paths among the nodes 111, and the like.

As previously discussed, in addition to maintaining a physical inventory, the in-memory metadata database may further provide a catalog of metadata for objects stored in object store 116 (e.g., what composite and components exist, what components belong to what composite objects, which nodes serve as “coordinators” or “owners” that control access to which objects, quality of service requirements for each object, object configurations, the mapping of objects to physical storage locations, etc.). As previously discussed, sub-modules within vSAN module 114 may access the CMMDS sub-module for updates to learn of changes in cluster topology and object configurations.

In some cases, one or more nodes 111 within node cluster 110 may fail or go offline, resulting in a loss of access to the data and/or code blocks stored by such nodes. In such cases, the distributed storage system or vSAN environment 100 may have to be able to tolerate such a failure and efficiently reconstruct the missing data blocks. In some other cases, a node 111 may go offline temporarily and then come back online resulting in some out-of-sync data blocks. To address such cases, the distributed storage system may be configured with fault tolerance technologies to resync such out-of-sync data and/or code blocks. Accordingly, to increase performance efficiency and fault tolerance, distributed storage systems (e.g., vSAN environment 100) may implement a variety of fault tolerance technologies, such as the various levels of RAID and/or erasure coding, etc. As described above, depending on the required level of performance and fault tolerance (e.g., based on a dynamic fault tolerance policy), virtual disk blueprint 215 may direct composite object 200 to be distributed in one of several ways. In some embodiments, one or a combination of RAID levels (e.g. RAID 0 to RAID 6) may be used, where each RAID level or a combination thereof may provide a different level of fault tolerance and performance enhancement.

For example, FIG. 2 illustrates an example of the application of RAID 1, which entails creating a replica of composite object 200. This is to ensure that a second copy (e.g., branch object 200b) of composite object 200 is still available if a first copy (e.g., branch object 200a) is lost due to some sort of failure (e.g. disk failure etc.). In some embodiments, some objects may require a more robust fault tolerance system (e.g., depending on their level of importance). For example, in one embodiment, the vSAN datastore may store the metadata object (in the performance tier) in a three-way mirror format (e.g., on at least three different disks).

FIG. 2 also illustrates the application of RAID 1 to the two copies of composite object 200 (branch object 200a and branch object 200b, created as a result of RAID 1). Under RAID 1, each copy of composite object 200 may be partitioned into smaller data stripes, where each stripe is further segmented into a number of data blocks (e.g., DB1, DB2, in the first stripe, and DB3, DB4, in the second stripe) and distributed across local storage resources of various nodes in the datastore. In some cases, striping a copy of composite object 200 over local storage resources of various nodes may enhance performance as compared to storing the entire copy of composite object 200 in a single node. This is because striping the data means that smaller amounts of data are written to or read from local storage resources of multiple nodes in parallel, thereby reducing the amount of time to complete a particular read or write operation. However, multiplying the number of nodes used to store the various chunks of data may increase the probability of failure, and thus data loss.

To achieve an even higher level of fault tolerance with much less space usage than RAID 1, erasure coding is applied in some embodiments. Erasure coding (EC) is a method of data protection in which each copy of composite object 200 is partitioned into stripes, expanded and encoded with redundant data pieces, and stored across different nodes of the datastore. For example, a copy of composite object 200 is organized or partitioned into stripes, each of which is broken up into N equal-sized data blocks. Erasure codes are then used to encode an additional M equal-sized code block(s) (interchangeably referred to as “parity blocks”) from the original N data blocks, where N is a larger number than M.

The M equal-sized code block(s) then provide fault tolerance and enable reconstruction of one or more lost data blocks in the same stripe should one or more of the underlying nodes fail. More specifically, each code block includes parity values computed from the N data blocks in the same stripe using an erasure coding algorithm. An application of an exclusive OR (i.e., XOR) operation to the N data blocks of the stripe, for computing a code block, is one example of applying an erasure coding algorithm, in which case the computed code block contains the XOR of data corresponding to the N data blocks in the stripe. In such an example, if one of the N data blocks is lost due a failure of its underlying node, the datastore object may be able to be reconstructed by performing an XOR operation of the remaining data blocks as well as the computed code block(s) in the same stripe. Depending on the level of fault tolerance desired, different erasure codes are applied in creating the one or more M code blocks. RAID 5 and RAID 6 are common examples of applying erasure coding. In RAID 5, an exclusive OR (i.e. XOR) operation is performed on multiple data blocks to compute a single parity block.

FIG. 3 is an illustration 300 of a stretched cluster, according to an example embodiment of the present application. Illustration 300 includes nodes 111a, 111b, 111c, and 111d of FIG. 2.

Cluster 310, which may correspond to cluster 110 of FIG. 1, represents a multi-site storage cluster, such as a stretched cluster. A stretched cluster improves data availability by including redundant copies of data across multiple sites in addition to any fault tolerance that exists within a single site.

Cluster 310 includes nodes 111a and 111b, which are located on a first site 320, nodes 111c and 111d, which are located on a second site 330, and a witness node 342, which is located on a third site 340. For example, sites 320, 330, and 340 may correspond to separate physical locations. In one example, sites 320, 330 and 340 are data centers. Sites 320, 330, and 340 are connected to one another via a network 350, such as a wide area network (WAN).

Witness node 342 represents a computing entity such as a host machine or a VCI (e.g., a virtual appliance) that serves as a tie-breaker between nodes in site 320 and nodes in site 330 in the event that sites 320 and 330 become partitioned from one another. Witness node 342 stores cross-site witness components, which are meta-data components that are dynamically added to objects with dual site mirroring policies (e.g., objects that are mirrored on stretched cluster across two sites) and are used as the tie-breaking vote when determining object availability. In the event of a failure, each site can use its connection to witness node 342 to measure its independent health, with the “surviving” site restarting any failed workloads and the “failed” site shutting down any running workloads. In some cases, witness node 342 may be a witness appliance. A witness appliance is a preconfigured VCI or device that has a sole purpose of serving as a witness.

While not shown, sites 320 and 330 may each also include a witness node that serves as a tie-breaker between nodes within an individual site when needed.

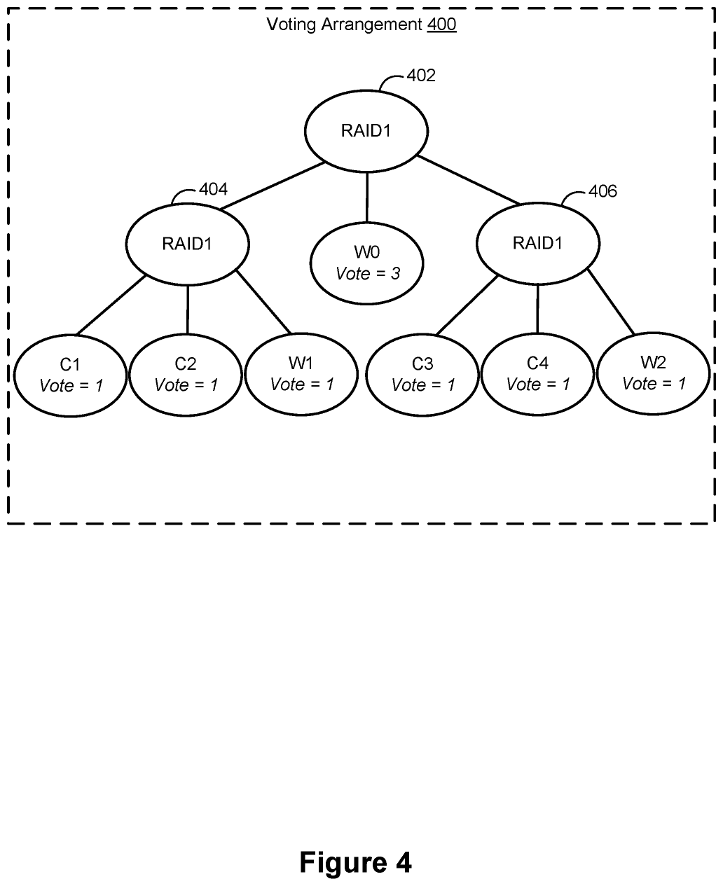

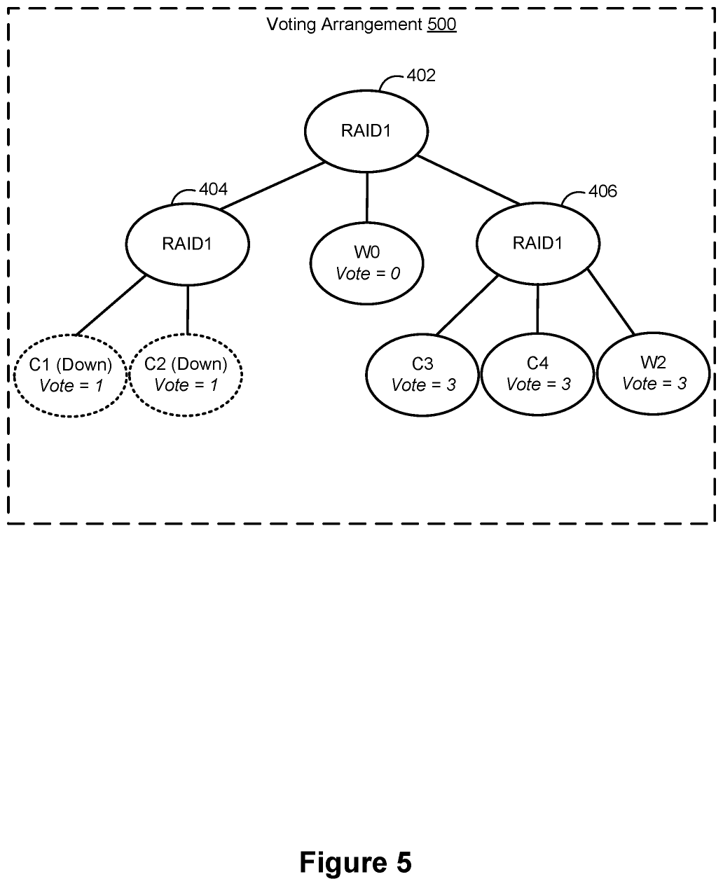

Voting arrangements for an object stored on cluster 310 are described in more detail below with respect to FIGS. 4 and 5

FIG. 4 is a 400 illustrating an example voting arrangement 400 for a storage object associated with a stretched cluster. For instance, voting arrangement 400 may represent a voting arrangement for file system object 205 of FIG. 2, which may be stored on cluster 310 of FIG. 3.

A fault tolerant storage arrangement for the storage object includes a multi-site RAID 1 configuration 402 that includes a first RAID 1 configuration 404 on a first site (e.g., site 330 of FIG. 3) and a second RAID 1 configuration 406 on a second site (e.g., site 320 of FIG. 3). A witness node W0 (e.g., corresponding to witness 342 on site 340 of FIG. 3) serves as a cross-site witness for breaking ties between the two sites. W0 is assigned 3 votes.

Within the first RAID 1 configuration 404 on the first site, components C1 and C2 may correspond to components 220a and 220b of FIG. 2, and may be stored on separate nodes (e.g., nodes 111a and 111b of FIG. 2). In some embodiments, components C1 and C2 are duplicate copies of the same component, while in other embodiments components C1 and C2 differ (e.g., if erasure coding is used). Components C1 and C2 are each assigned 1 vote and a witness node W1 is also assigned 1 vote. Within the second RAID 1 configuration 406 on the second site, components C3 and C4 may correspond to components 220c and 220d of FIG. 2, and may be stored on separate nodes (e.g., nodes 111c and 111d of FIG. 2). In some embodiments, components C3 and C4 are duplicate copies of the same component, while in other embodiments components C3 and C4 differ (e.g., if erasure coding is used). Components C3 and C4 are each assigned 1 vote and a witness node W2 is also assigned 1 vote. It is noted that while C1, C2, C3, and C4 are referred to as “components”, C1, C2, C3, and C4 may represent the nodes on which these components are stored rather than the components themselves, and votes may be assigned to nodes rather than to components.

In order to achieve a quorum, a group of nodes must reach a majority of all possible votes. In the present case, the total number of votes is 9, so a group of nodes must reach 5 votes to achieve a quorum. Thus, in voting arrangement 400, any two nodes (totaling 2 votes) within the first site or the second site can achieve a quorum if they can communicate with witness node W0 (totaling 3 votes), thereby reaching 5 votes.

In an example, if C1 and C2 are both able to communicate with each other and with W0, then they can achieve a quorum. In another example, if C2 is unavailable but C1 can communicate with W1 and W0, it can achieve a quorum.

In yet another example, if the first site is unavailable, but C3 and C4 are both available (or one of C3 or C4 is available and communicate with W2), and can also communicate with W0, then a quorum can still be achieved. However, if W0 becomes unavailable while the first site remains unavailable, then a quorum cannot be achieved in voting arrangement 400 even if C3 and/or C4 can still provide data availability. As such, voting arrangement 500 of FIG. 5, described below, allows nodes of a surviving site to achieve a quorum without any votes from nodes of a failed site or W0.

FIG. 5 is a diagram illustrating another example voting arrangement 500 for a storage object associated with a stretched cluster. For instance, voting arrangement 500 may represent a voting arrangement for file system object 205 of FIG. 2, which may be stored on cluster 310 of FIG. 3.

Voting arrangement 500 includes RAID 1 configurations 402, 404, and 406, components C1, C2, C3, and C4, and witness nodes W0 and W2 of FIG. 4.

Voting arrangement 500 corresponds to a situation where the first site is unavailable, leading to C1 and C2 being down (e.g., unavailable). For example, a cluster level object manager (CLOM) within a VSAN module (e.g., VSAN module 114 of FIG. 2) on a node (e.g., node 111a) on which the VCI that uses the storage object (e.g., if the storage object is a virtual disk of the VCI) is located may interact with a distributed object manager (DOM) of the VSAN module to determine that C1 and C2 are unavailable. In some embodiments, the DOM of the VSAN module of the node on which the VCI that uses the storage object is located interacts with a corresponding DOM on each of one or more other nodes on which components of the storage object are stored in order to determine availability of components. In certain embodiments, if a DOM of a node on which a component is located is unresponsive, this may indicate that the component is unavailable. Upon determining that C1 and C2 are unavailable, the CLOM may then modify voting arrangement 400 to produce voting arrangement 500, thereby providing site resilience.

In voting arrangement 500, C1 and C2 each still have 1 vote (e.g., by default). W0 is assigned 0 votes. C3, C4, and W2 are each assigned 3 votes. Thus, voting arrangement 500 includes a total of 11 votes, and a group of nodes must reach 6 votes to achieve a quorum. As such, a quorum may be achieved by any two nodes within the second site (e.g., under RAID 1 configuration 406), each of which is assigned 3 votes.

By assigning 0 votes to W0, voting arrangement 500 allows any two nodes in the second site to achieve a quorum even in the event that W0 becomes unavailable. In such a case, there is no possibility of a split-brain situation occurring, because only one site is available. Thus, W0's intended function of breaking a tie between the two sites is not needed as long as the first site remains unavailable, and W0 can be assigned 0 votes during that time.

Accordingly, with voting arrangement 500, if W0 becomes unavailable but C3 and C4 are both available (or one of C3 or C4 is available and can communicate with W2), then a quorum can still be achieved, and data access is allowed.

If the first site again becomes available (e.g., C1 and C2 becoming available), then voting arrangement 500 may remain in place until one or both of C1 and C2 have been re-synchronized with the current state of the data (e.g., to account for writes that may have been missed while C1 and C2 were down). Once one or both of C1 and C2 have been re-synchronized, and data availability is again provided on the first site, then the voting arrangement may be restored to its earlier state (e.g., back to voting arrangement 400 of FIG. 4). If W0 had become unavailable, then the voting arrangement may not be restored to its earlier state until W0 has again become available.

It is noted that the particular voting arrangements depicted and described herein are included as examples, and other voting arrangements may be utilized without departing from the scope of the present disclosure. For example, different amounts of votes than those set forth herein may be assigned to components and witness nodes, while still allowing a quorum to be achieved by a single surviving site without requiring any votes from a failed site or from a witness node.

It is further noted that techniques described herein apply to situations where one site in a multi-site cluster becomes unavailable while a witness node is still available. Thus, the surviving site is able to determine that it is indeed the surviving site owing to its connection to the witness node. A voting arrangement may then be modified as described herein to allow the surviving site to achieve a quorum without the failed site or the witness node, to account for potentiality of the witness node subsequently becoming unavailable. However, if the witness node were to become unavailable before one of the sites becomes unavailable, the surviving site may be unable to determine that it is the surviving site, and so may be unable to provide data access.

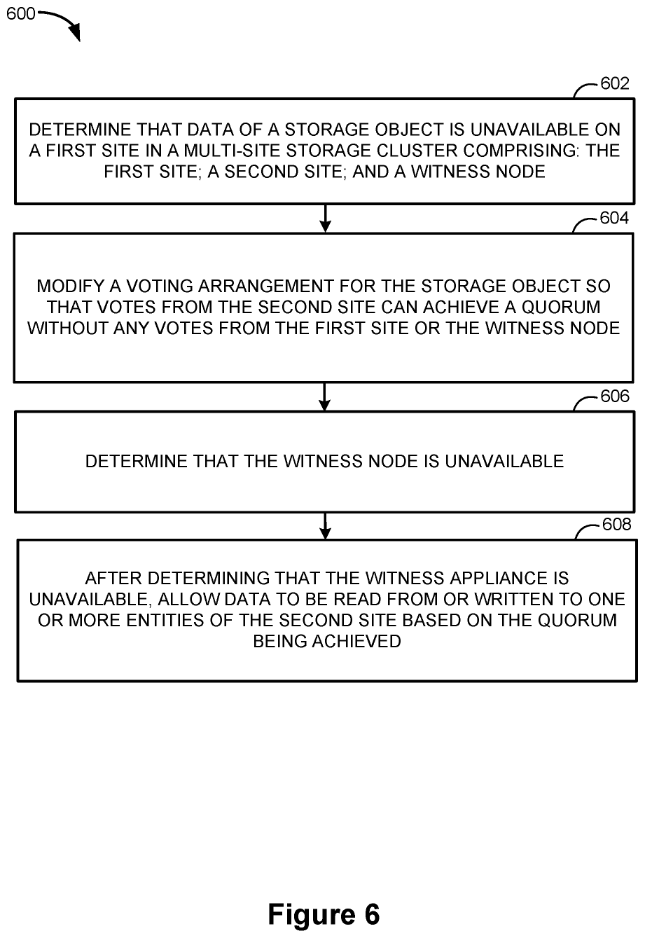

FIG. 6 is a flowchart illustrating example operations 600 for dynamic fault tolerance in a stretched storage cluster, according to an example embodiment of the present application. Operations 600 may be performed, for example, by vSAN module 114, as described above with reference to FIGS. 1 and 2. In certain other embodiments, the operations may be performed by some other modules that reside in the hypervisor or outside of the hypervisor of a host machine.

Operations 600 begin at step 602, with determining that data of a storage object is unavailable on a first site in a multi-site storage cluster comprising: the first site; a second site; and a witness node. In some embodiments, the storage object is configured with a number of host failures to tolerate (HFT) of one. Tolerating one host failure may mean that up to one host failure is tolerated on each site or that one host failure in total is tolerated across all sites. For example, each individual site may implement fault tolerance via replication within the site or, alternatively, fault tolerance may be implemented by using multiple sites, and each individual site may not separately implement fault tolerance. In a stretched cluster of two sites, for instance, if one host failure is tolerated (e.g., regardless of whether fault tolerance is implemented within each individual site), then up to one site failure may be tolerated.

Operations 600 continue at step 604, with modifying a voting arrangement for the storage object so that votes from the second site can achieve a quorum without any votes from the first site or the witness node. In some embodiments, modifying the voting arrangement for the storage object comprises assigning no votes to the witness node. In certain embodiments, modifying the voting arrangement for the storage object comprises increasing a number of votes assigned to one or more entities (e.g., nodes, components, witness nodes, and/or the like) on the second site.

Operations 600 continue at step 606, with determining that the witness node is unavailable. For example, determining that the witness node is unavailable may comprise determining that witness node is inaccessible after modifying the voting arrangement for the storage object. In some embodiments, the witness node is determined to be unavailable based on a determination that the witness node is inaccessible on the network or otherwise unresponsive. This determination may be made by a CLOM and/or DOM in a VSAN module of a node on which a VCI that uses the storage object (e.g., if the storage object is a virtual disk of the VCI) is located, such as based on an attempt to communicate with the witness node.

Operations 600 continue at step 604, with, after determining that the witness node is unavailable, allowing data to be read from or written to one or more entities of the second site based on the quorum being achieved.

Some embodiments further comprise determining that the data of the storage object is available on the first site, determining that the witness node is available, and restoring the voting arrangement for the storage object to its state prior to the modifying. Determining that the data of the storage object is available on the first site may comprise determining that the data has been synchronized on the first site with a current state of the data.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for dynamic fault tolerance in a stretched storage cluster, comprising:
determining that data of a storage object is unavailable on a first site in a multi-site storage cluster comprising:
the first site;
a second site; and
a witness node;
modifying a voting arrangement for the storage object so that votes from the second site can achieve a quorum without any votes from the first site or the witness node;
determining that the witness node is unavailable; and
after determining that the witness node is unavailable, allowing data to be read from or written to one or more entities of the second site based on the quorum being achieved.

2. The method of claim 1, wherein the storage object is configured with a number of host failures to tolerate (HFT) of one.

3. The method of claim 1, wherein modifying the voting arrangement for the storage object comprises assigning no votes to the witness node.

4. The method of claim 1, wherein modifying the voting arrangement for the storage object comprises increasing a number of votes assigned to one or more entities on the second site.

5. The method of claim 1, further comprising:
determining that the data of the storage object is available on the first site;
determining that the witness node is available; and
restoring the voting arrangement for the storage object to its state prior to the modifying.

6. The method of claim 5, wherein determining that the data of the storage object is available on the first site comprises determining that the data has been synchronized on the first site with a current state of the data.

7. The method of claim 1, wherein determining that the witness node is unavailable comprises determining that witness node is inaccessible after modifying the voting arrangement for the storage object.

8. A system for dynamic fault tolerance in a stretched storage cluster, comprising:
at least one memory; and
at least one processor coupled to the at least one memory, the at least one processor and the at least one memory configured to:
determine that data of a storage object is unavailable on a first site in a multi-site storage cluster comprising:
the first site;
a second site; and
a witness node;
modify a voting arrangement for the storage object so that votes from the second site can achieve a quorum without any votes from the first site or the witness node;
determine that the witness node is unavailable; and
after determining that the witness node is unavailable, allow data to be read from or written to one or more entities of the second site based on the quorum being achieved.

9. The system of claim 8, wherein the storage object is configured with a number of host failures to tolerate (HFT) of one.

10. The system of claim 8, wherein modifying the voting arrangement for the storage object comprises assigning no votes to the witness node.

11. The system of claim 8, wherein modifying the voting arrangement for the storage object comprises increasing a number of votes assigned to one or more entities on the second site.

12. The system of claim 8, wherein the at least one processor and the at least one memory are further configured to:
determine that the data of the storage object is available on the first site;
determine that the witness node is available; and
restore the voting arrangement for the storage object to its state prior to the modifying.

13. The system of claim 12, wherein determining that the data of the storage object is available on the first site comprises determining that the data has been synchronized on the first site with a current state of the data.

14. The system of claim 8, wherein determining that the witness node is unavailable comprises determining that witness node is inaccessible after modifying the voting arrangement for the storage object.

15. A non-transitory computer-readable medium storing instructions that, when executed by one or more processors, cause the one or more processors to:
determine that data of a storage object is unavailable on a first site in a multi-site storage cluster comprising:
the first site;
a second site; and
a witness node;
modify a voting arrangement for the storage object so that votes from the second site can achieve a quorum without any votes from the first site or the witness node;
determine that the witness node is unavailable; and
after determining that the witness node is unavailable, allow data to be read from or written to one or more entities of the second site based on the quorum being achieved.

16. The non-transitory computer-readable medium of claim 15, wherein the storage object is configured with a number of host failures to tolerate (HFT) of one.

17. The non-transitory computer-readable medium of claim 15, wherein modifying the voting arrangement for the storage object comprises assigning no votes to the witness node.

18. The non-transitory computer-readable medium of claim 15, wherein modifying the voting arrangement for the storage object comprises increasing a number of votes assigned to one or more entities on the second site.

19. The non-transitory computer-readable medium of claim 15, wherein the instructions, when executed by the one or more processors, further cause the one or more processors to:
determine that the data of the storage object is available on the first site;
determine that the witness node is available; and
restore the voting arrangement for the storage object to its state prior to the modifying.

20. The non-transitory computer-readable medium of claim 19, wherein determining that the data of the storage object is available on the first site comprises determining that the data has been synchronized on the first site with a current state of the data.
